(19) United States
(12) Patent Application Publication
(10) Pub. No.: US 2026/0110820 A1
(43) Pub. Date: Apr. 23, 2026

(54) EXPERIMENTAL TESTING SYSTEMS AND METHODS FOR WELLBORE PRESSURES DURING WELL KILLING PROCESSES UNDER COMPLEX WORKING CONDITIONS

(71) Applicant: SOUTHWEST PETROLEUM UNIVERSITY, Chengdu (CN)

(72) Inventors: Jie ZHANG, Chengdu (CN); Rongxin LI, Chengdu (CN); Runze LI, Chengdu (CN); Xiaojie LIU, Chengdu (CN); Cuinan LI, Chengdu (CN); Qiang WEI, Chengdu (CN); Mubai DUAN, Chengdu (CN); Zhilin LI, Chengdu (CN); Jiajun YAO, Chengdu (CN); Yao WANG, Chengdu (CN)

(73) Assignee: SOUTHWEST PETROLEUM UNIVERSITY, Chengdu (CN)

(21) Appl. No.: 19/052,328

(22) Filed: Feb. 13, 2025

(30) Foreign Application Priority Data
Oct. 18, 2024 (CN) 202411456449.9

(51) Int. Cl. G01V 99/00; E21B 41/00

(52) U.S. Cl. CPC G01V 99/00; E21B 41/00

(57) ABSTRACT

An experimental testing system and method for a wellbore pressure during a well killing process under a complex working condition are provided. The experimental testing system includes a target high-pressure formation simulation device, a wellbore, a drilling string, a blowout preventer, a drilling fluid reservoir, a kill fluid reservoir, a mud mixing pit, a mud pump, a high-pressure gas storage tank, a drilling tool lifting device, a three-way connector, a water hose, a data receiving terminal, and a drilling bit. The embodiments of the present disclosure may predict the wellbore pressure during the well killing process by combining a variety of conditions and simulating the well killing manners under different complex conditions.

### CROSS-REFERENCE TO RELATED APPLICATIONS

This application claims priority to Chinese Patent Application No. 202411456449.9, filed on Oct. 18, 2024, the entire contents of which are hereby incorporated by reference.

### TECHNICAL FIELD

The present disclosure relates to the field of oil and natural gas drilling engineering, and in particular, to experimental testing systems and methods for wellbore pressures during well killing processes under complex working conditions.

### BACKGROUND

In the process of oil drilling, especially in the process of deep earth drilling, due to the unconventional borehole and large borehole size, long drilling cycle, and the existence of multiple sets of complex pressure systems in the formation, it is prone to occur a variety of complex working conditions such as gas intrusion, well surging, and leakage, etc., during the drilling process. The impact of gas intrusion is the most severe, and it is crucial to shut in the well and kill the well after the gas intrusion occurs. By monitoring and analyzing the pressure conditions of the entire wellbore, a reasonable pressure control plan can be formulated to ensure the success of the well killing process and minimize secondary risks such as subsequent gas intrusion or wellbore leakage.

For conventional-sized boreholes experiencing gas intrusion, three common methods are typically employed for shutting in the well and killing the well, including the conventional single circulation method, the two-circulation method, and the bullheading method. However, for unconventional large-sized boreholes, the situation is more complex due to the large borehole size, high drilling fluid displacement, and significant circulation pressure loss. After gas intrusion and overflow occur, the well is shut in after lifting the drilling tool assembly, and a pressure situation within the wellbore is not yet clear, leading to substantial safety risks at the wellhead during the killing well process.

Therefore, it is necessary to provide an experimental testing system and method for a wellbore pressure during a well killing process under a complex working condition. By combining a variety of conditions and simulating well killing manners under different complex conditions, the wellbore pressure during the well killing process can be predicted to monitor the safety risk at the wellhead.

### SUMMARY

One or more embodiments of the present disclosure provide an experimental testing system for a wellbore pressure during a well killing process under a complex working condition. The system may include a target high-pressure formation simulation device, a wellbore, a drilling string, a blowout preventer, a drilling fluid reservoir, a kill fluid reservoir, a mud mixing pit, a mud pump, a high-pressure gas storage tank, a drilling tool lifting device, a three-way connector, a water hose, a data receiving terminal, and a drilling bit. An upper end and a lower end of the wellbore may be connected to the blowout preventer and the target high-pressure formation simulation device by flanges, respectively. Two sides of the blowout preventer may be provided with a first electric valve and a second electric valve. The drilling string may be vertically installed in the blowout preventer, and a bottom end of the drilling string may be connected to the drilling bit and extends into the target high-pressure formation simulation device. The drilling string may be located on an outer wall inside the wellbore, and three stabilizers may be provided on the outer wall. A left end of the three-way connector may be connected to the mud pump through a pipe, a right end of the three-way connector may be connected to the first electric valve through a pipe, and an upper end of the three-way connector may be connected to a top end of the drilling string through the water hose. A liquid flow meter and a second one-way valve may be provided between the mud pump and the three-way connector. The mud pump may be connected to the drilling fluid reservoir and the kill fluid reservoir through pipes, respectively, and the mud mixing pit may be connected to the drilling fluid reservoir and the kill fluid reservoir through pipes, respectively. The top end of the drilling string may be connected to the drilling tool lifting device, which may be configured to lift the drilling string. The high-pressure gas storage tank may be connected to the target high-pressure formation simulation device by a pipe, and a pressure reducing valve, a gas flow meter, a first one-way valve, and a first pressure sensor may be provided between the target high-pressure formation simulation device and the high-pressure gas storage tank. The wellbore may be provided with a second pressure sensor, a third pressure sensor, and a fourth pressure sensor in sequence from bottom to top, and the first pressure sensor, the second pressure sensor, the third pressure sensor, the fourth pressure sensor, and the liquid flow meter may be all electrically connected to the data receiving terminal

One or more embodiments of the present disclosure provide an experimental testing method for a wellbore pressure during a well killing process under a complex working condition. The method may be tested using the experimental testing system for the wellbore pressure during the well killing process under the complex working condition as described in an embodiment of the present disclosure. The method may include adjusting an eccentricity of the drilling string by adjusting a placement position of the stabilizers; preparing a drilling fluid with a required density by the density adjustment pit and the viscosity adjustment pit, and storing the drilling fluid in the drilling fluid reservoir; turning on the mud pump, the drilling fluid passing through the liquid flow meter, the three-way connector, and the water hose in sequence to enter the drilling string from the top end of the drilling string, and then passing through the drilling bit to enter into the target high-pressure formation simulation device, an inlet flow rate being a reading Q₁ of the liquid flow meter; the drilling fluid that enters the target high-pressure formation simulation device entering the blowout preventer through an annulus between the drilling string and the wellbore, and then passing through the second electric valve and the waste liquid flow meter in sequence to enter the waste liquid treatment pit, flowing out from a bottom of the waste liquid treatment pit after treatment in the waste liquid treatment pit to enter the mud mixing pit and the drilling fluid reservoir, and then the drilling fluid entering into a circulation again from the drilling fluid reservoir, an outlet flow rate being a reading Q₂ of the waste liquid flow met; determining, after circulating for a time period, whether the inlet flow rate is equal to the outlet flow rate; in response to determining that the inlet flow rate is equal to the outlet flow rate, indicating that the circulation is normal, continuing to a next operation; in response to determining that the inlet flow rate is not equal to the outlet flow rate, stopping the circulation and find out a reason to start the circulation again until the inlet flow rate is equal to the outlet flow rate, then continuing to next operation, readings of the first pressure sensor, the second pressure sensor, the third pressure sensor, and the fourth pressure sensor being P₁, P₂, P₃, and P₄, respectively; opening a high-pressure gas storage tank during the circulation, high-pressure gas entering the target high-pressure formation simulation device through the pressure reducing valve, the gas flow meter, and the first pressure sensor; a pressure of the pressure reducing valve being P_{g}, a reading of the gas flow meter being Q_{g1}, and a reading of the first pressure sensor being P′₁: the high-pressure gas that enters the target high-pressure formation simulation device being returned from the annulus together with the drilling fluid, and then entering into the waste liquid treatment pit through the second electric valve and the waste liquid flow meter, readings of the second pressure sensor, the third pressure sensor, the fourth pressure sensor, and the waste liquid flow meter being P′₂, P′₃, P′₄, and Q₃, respectively; turning off the mud pump and simultaneously turning on the drilling tool lifting device, stopping lifting after lifting the drilling string above the target high-pressure formation simulation device, turning off the second electric valve, and shutting-in well successfully; preparing a kill fluid with a required density in the mud mixing pit, and storing the kill fluid in the kill fluid reservoir; turning on the mud pump, adjusting a displacement of the kill fluid to a target value, the kill fluid passing through the liquid flow meter, the three-way connecter, and the water hose in sequence to enter into the drilling string from the top end of the drilling string, and then passing through the drilling bit to enter into the target high-pressure formation simulation device, the reading of the liquid flow meter being Qₘ₁; the kill fluid that enters the target high-pressure formation simulation device entering the blowout preventer through the annulus between the drilling string and the wellbore, passing through the second electric valve and the waste liquid flow meter in sequence to enter the waste liquid treatment pit, flowing out from the bottom of the waste liquid treatment pit after treatment in the waste liquid treatment pit, to enter the mud mixing pit and the kill fluid reservoir, then the kill fluid entering into a circulation again, the reading of the waste liquid flow meter being Qₘ₂; the readings of the first pressure sensor, the second pressure sensor, the third pressure sensor, and the fourth pressure sensor being P″₁, P″₂, P″₃, and P″₄, respectively; continuing to inject gas and injecting the kill fluid for the circulation until there is no gas in the wellbore, wherein final circulation pressures measured by the first pressure sensor, the second pressure sensor, the third pressure sensor, and the fourth pressure sensor are P^{e}₁, P^{e}₂, P^{e}₃, and P^{e}₄, respectively; and turning off the high-pressure gas storage tank and the mud pump, and completing the well killing process.

The embodiments of the present disclosure include but are not limited to the following beneficial effects. By combining a variety of conditions and simulating well killing manners under different complex conditions, the wellbore pressure during the well killing process can be predicted to monitor the safety risk at the wellhead.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a schematic diagram illustrating an exemplary experimental testing system for a wellbore pressure during a well killing process under a complex working condition according to some embodiments of the present disclosure;

FIG. 2 is a flowchart illustrating an exemplary experimental testing method for a wellbore pressure during a well killing process under a complex working condition according to some embodiments of the present disclosure;

FIG. 3 is a schematic diagram illustrating an exemplary estimation model according to some embodiments of the present disclosure; and

FIG. 4 is a schematic diagram illustrating an exemplary anomaly prediction model according to some embodiments of the present disclosure.

Description of markers in the accompanying drawings: 1—density adjustment pit, 2—viscosity adjustment pit, 3—mud mixing pit, 4—drilling fluid reservoir, 5—kill fluid reservoir, 6—mud pump, 7—high-pressure gas storage tank, 8—target high-pressure formation simulation device, 9—electric winch, 10—blowout preventer, 11—wellbore, 12—stabilizer, 13—drilling string, 14—drilling bit, 15—first pulley set, 16—waste liquid treatment pit, 17—three-way connector, 18—liquid flow meter, 19—second one-way valve, 20—gas flow meter, 21—first pressure sensor, 22—first electric valve, 23—pressure reducing valve, 24—second electric valve, 25—water hose, 26—first one-way valve, 27—waste liquid flow meter, 28—wire rope, 29—data receiving terminal, 30—second pulley set, 31—annulus, 32—third pulley set, 33—second pressure sensor, 34—third pressure sensor, 35—fourth pressure sensor.

### DETAILED DESCRIPTION

Exemplary embodiments or implementations will be described herein in detail, examples of which are represented in the accompanying drawings. When the following description relates to the accompanying drawings, the same numerals in the different accompanying drawings denote the same or similar elements unless otherwise indicated. The embodiments described in the following exemplary embodiments are not intended to be representative of all embodiments consistent with the present disclosure. Instead, they are only examples of devices and methods that are consistent with some aspects of the present disclosure as detailed in the appended claims.

Terms used in the present disclosure are used solely for the purpose of describing particular embodiments and are not intended to limit the present disclosure. As used in the present disclosure and the appended claims, the singular forms of “a”, “an” and “the” as used in the present disclosure and the appended claims are also intended to include the plural form, unless the context clearly indicates otherwise.

It is to be understood that the terms “first”, “second”, or the like as used in the present disclosure and the claims do not indicate any order or importance, but are used only to distinguish different components. Similarly, the words “a” or “one”, or the like do not indicate a quantitative limitation but rather indicate the presence of at least one component. Unless otherwise noted, “front”, “back”, “lower”, and/or “upper”, and similar terms, are used for illustrative purposes only and are not limited to a position or spatial orientation. Words such as “including” or “comprising” refer to elements or objects that appear before “including” or “comprising”, including those listed after “including” or “comprising” and their equivalents, and do not exclude other elements or objects.

The experimental testing system and method for the wellbore pressure during the well killing process under the complex working condition of one or more embodiments of the present disclosure are mainly applied in an experimental drilling process, especially in scenarios of working conditions such as a deep well and a complex well.

It should be understood that the application scenarios of the present disclosure of the experimental testing system and method for the wellbore pressure during the well killing process under the complex working condition are only some examples or embodiments of the present disclosure. For a person of ordinary skill in the art, the present disclosure may be applied to other similar scenarios in accordance with the accompanying drawings without the expenditure of creative labor.

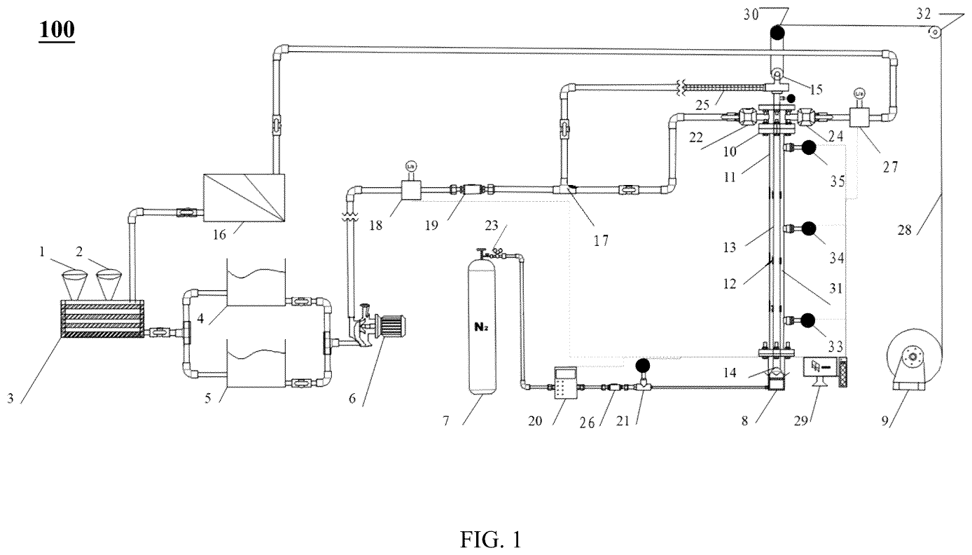

FIG. 1 is a schematic diagram illustrating an exemplary experimental testing system for a wellbore pressure during a well killing process under a complex working condition according to some embodiments of the present disclosure.

As shown in FIG. 1, an experimental testing system for a wellbore pressure during a well killing process under a complex working condition is provided in the embodiment of the present disclosure. The experimental testing system for the wellbore pressure during the well killing process under the complex working condition 100 (hereinafter referred to as the experimental testing system 100) includes a target high-pressure formation simulation device 8, a wellbore 11, a drilling string 13, a blowout preventer 10, a drilling fluid reservoir 4, a kill fluid reservoir 5, a mud mixing pit 3, a mud pump 6, a high-pressure gas storage tank 7, a drilling tool lifting device, a three-way connector 17, a water hose 25, a data receiving terminal 29, and a drilling bit 14. An upper end and a lower end of the wellbore 11 are connected to the blowout preventer 10 and the target high-pressure formation simulation device 8 by flanges, respectively. Two sides of the blowout preventer 10 are provided with a first electric valve 22 and a second electric valve 24. The drilling string 13 is vertically installed in the blowout preventer 10 and a bottom end of the drilling string 13 is connected to the drilling bit 14 and extends into the target high-pressure formation simulation device 8. The drilling string 13 is located on an outer wall inside the wellbore 11, and three stabilizers 12 are provided on the outer wall. A left end of the three-way connector 17 is connected to the mud pump 6 through a pipe, a right end of the three-way connector 17 is connected to the first electric valve 22 through a pipe, and an upper end of the three-way connector 17 is connected to a top end of the drilling string 13 through the water hose 25. A liquid flow meter 18 and a second one-way valve 19 are provided between the mud pump 6 and the three-way connector 17. The mud pump 6 is connected to the drilling fluid reservoir 4 and the kill fluid reservoir 5 through pipes, respectively, and the mud mixing pit 3 is connected to the drilling fluid reservoir 4 and the kill fluid reservoir 5 through pipes, respectively. The top end of the drilling string 13 is connected to the drilling tool lifting device, which is configured to lift the drilling string 13. The high-pressure gas storage tank 7 is connected to the target high-pressure formation simulation device 8 by a pipe, and a pressure reducing valve 23, a gas flow meter 20, a one-way valve 26, and a first pressure sensor 21 are provided between the target high-pressure formation simulation device 8 and the high-pressure gas storage tank 7. The wellbore 11 is provided with a second pressure sensor 33, a third pressure sensor 34, and a fourth pressure sensor 35 in sequence from bottom to top, and the first pressure sensor 21, the second pressure sensor 33, the third pressure sensor 34, the fourth pressure sensor 35, and the liquid flow meter 18 are all electrically connected to the data receiving terminal 29.

The well killing process refers to a process of re-establishing the pressure of the fluid column in the wellbore to balance the formation pressure by injecting kill fluid with an appropriate density into the well when overflow occurs during the drilling process. Precise experimental testing of the pressure in the wellbore is required during the well killing process to balance the formation pressure.

The wellbore refers to a vertical or inclined passageway from the surface of the ground to the subsurface oil and gas resources or other mineral deposits during the drilling process.

In some embodiments, as shown in FIG. 1, the upper end and the lower end of the wellbore 11 are connected to the blowout preventer 10 and the target high-pressure formation simulation device 8 by flanges, respectively. In some embodiments, the two sides of the blowout preventer 10 are provided with the first electric valve 22 and the second electric valve 24. In some embodiments, the drilling string 13 is vertically installed in the blowout preventer 10, and the bottom end of the drilling string 13 is connected to the drilling bit 14 and extends into the target high-pressure formation simulation device 8. The drilling string 10 is located on the outer wall inside the wellbore 11, and three stabilizers 12 are provided on the outer wall.

A flange refers to a component used to connect pipes, valves, pumps, and other devices to form a pipeline system. In some embodiments, the flange may include one or more of a sliding flange, a butt-welding flange, a flat-welding flange, a socket-welding flange, a threaded flange, a blind flange, etc. In some embodiments, the material of the flange may include one or more of the carbon steel, stainless steel, alloy steel, plastic, composite materials, etc. In some embodiments, an upper end of the wellbore 11 is connected to the blowout preventer 10 by a flange, and a lower end of the wellbore 11 is connected to the target high-pressure formation simulation device 8 by a flange.

The blowout preventer 10 refers to a safety device used in oil and gas drilling operations. During the drilling process, the blowout preventer 10 may maintain a safe operating environment by controlling the pressure at the wellhead to prevent blowout accidents such as the violent spewing of oil, gas, or mud caused by the underground pressure. In some embodiments, the blowout preventer 10 may include an annular blowout preventer and a gate blowout preventer.

The target high-pressure formation simulation device 8 refers to an experimental device for oil, gas, and geological research, which is designed to simulate actual conditions of underground high-pressure formations. The target high-pressure formation simulation device 8 may simulate high-pressure formation conditions to test drilling mud performance, borehole stability, and well completion fluid performance.

In some embodiments, the target high-pressure formation simulation device 8 may have a variety of shapes, for example, a cubic shape, a rectangular shape, an annular shape, a multilayer structure, or any combination of shapes.

In some embodiments, the target high-pressure formation simulation device 8 is of a cylindrical shape. The target high-pressure formation simulation device 8 with the cylindrical shape can effectively withstand high pressures applied in a plurality of directions while providing a uniform internal environment to simulate formation conditions.

The electric valve refers to a valve that is driven by a motor, which is suitable for scenarios that require precise control of fluid flow. The electric valve may be automatically controlled remotely. In some embodiments, the first electric valve 22 and the second electric valve 24 provided on two sides (e.g., opposite sides, i.e., left and right) of the blowout preventer 10 may automatically control the fluid passing through the blowout preventer 10, respectively.

The drilling string 13 refers to the primary tool used to transmit rotational force and downforce in drilling operations. The drilling string 13 includes a plurality of pipes and tools and connects a rotation table of a drilling rig and the drilling bit 14. The top end of the drilling string 13 is connected to the rotation table of the drilling rig, and the bottom end of the drilling string 13 is connected to the drilling bit 14. The rotation table drives the drilling string 13 to rotate, thus driving the drilling bit 14 to rotate to complete the drilling process. The drilling bit 14 refers to a tool used for crushing and cutting underground rock formations, which is usually connected to the lowest end of the drilling string 13. In some embodiments, the drilling bit 14 may include a roller cone bit, a diamond bit, and a polycrystalline diamond compact bit, etc.

The blowout preventer 10 is installed at the upper end of the wellbore 11, and the drilling string 13 is vertically installed in the blowout preventer 10, indicating that the drilling string 13 passes through a center channel of the blowout preventer 10 in a vertical direction.

The drilling string 13 also includes a drilling pipe, which consists of a plurality of long tubes connected, and is the main part of the drilling string 13. The drilling pipe is configured to transmit power, transport the drilling fluid, and connect other drilling tools.

The stabilizer 12 refers to a tool configured to stabilize and control the position of the drilling string in a borehole during drilling operations. The stabilizer 12 may maintain the drilling string 13 at a center position within the wellbore 11 to prevent the drilling string 13 from being excessively deflected in the borehole and ensure straightness or designed inclination of the borehole. In some embodiments, the stabilizer 12 may include a spiral stabilizer, an integral stabilizer, an interchangeable blade stabilizer, and a floating stabilizer. In some embodiments, an appropriate type and size of the stabilizer 12 may be selected based on borehole conditions (e.g., a borehole size, an inclination, and a geologic property). In some embodiments, the three stabilizers 12 on the outer wall inside the wellbore 11 may be arranged at a specific spacing, e.g., equidistant. In some embodiments, one or more stabilizers 12 may be provided on the outer wall of the wellbore 11. For example, the number of the stabilizers 12 may be 1, 2, 3, 5, 8, etc.

In some embodiments, as shown in FIG. 1, the left end of the three-way connector 17 is connected to the mud pump 6 through a pipe, the right end of the three-way connector 17 is connected to the first electric valve 22 through a pipe, and the upper end of the three-way connector 17 is connected to the top end of the drilling string 13 through by the water hose 25. The liquid flow meter 18 and the second one-way valve 19 are provided between the mud pump 6 and the three-way connector 17.

In some embodiments, the three-way connector may include an equal diameter three-way connector, an unequal diameter three-way connector, an L-shaped three-way connector, a T-shaped three-way connector, and a Y-shaped three-way connector. In embodiments of the present disclosure, the T-shaped three-way connector may be selected for mixing or distributing fluid. In some embodiments, the three-way connector is configured to connect the mud pump 6, the first electric valve 22, and the water hose 25.

The mud pump 6 refers to a device that transports the drilling fluid during drilling operations. The drilling fluid, also known as mud, plays a variety of roles in the drilling process, such as cooling the drilling bit, carrying drill cuttings, preventing the well wall from collapsing, and maintaining the pressure balance at the bottom of the well. The mud pump 6 enables the drilling fluid to circulate and flow to the bottom of the well and then carry drill cuttings back to the surface for recycle by sucking and pressurizing mud from a mud pit and delivering it into the drilling string 13. In some embodiments, as shown in FIG. 1, the annulus 31 between the drilling string 13 and the wellbore 11 may be configured to transport the drilling fluid.

In some embodiments, the mud pump 6 may include a reciprocating piston mud pump and a centrifugal pump. In some embodiments, the drilling fluid may include one or more of a water-based drilling fluid, an oil-based drilling fluid, a synthetic-based drilling fluid, a foam or gas-based drilling fluid, or the like.

In some embodiments, the liquid flow meter 18 may include one or more of a volumetric flow meter, a velocity flow meter, a mass flow meter, a differential pressure flow meter, or the like. The liquid flow meter 18 may manage the delivery amount of liquid to ensure accurate flow control.

In some embodiments, the one-way valve may include one or more of a lift one-way valve, a spin one-way valve, a butterfly one-way valve, a ball one-way valve, a diaphragm one-way valve, or the like. The second one-way valve 19 may be configured to control the delivery of the drilling fluid between the mud pump 6 and the three-way connector 17. Because there is a height difference between the mud pump 6 and the first electric valve 22, the second one-way valve 19 may prevent the drilling fluid from backing up in reverse into the mud pump 6.

In some embodiments, as shown in FIG. 1, the mud pump 6 is connected to the drilling fluid reservoir 4 and the kill fluid reservoir 5 by pipes, respectively, and the mud mixing pit 3 is also connected to the drilling fluid reservoir 4 and the kill fluid reservoir 5 by pipes, respectively.

The drilling fluid reservoir 4 provides space to accommodate a variety of drilling fluids for use in drilling operations and allows the drilling fluids to be circulated within the reservoir for solids separation and performance adjustment.

The kill fluid refers to a special drilling fluid used to equalize downhole pressures to prevent the blowout. The kill fluid reservoir 5 provides a secure storage space for quickly allocating kill fluid into the wellbore when needed and allows for mixing the kill fluid and performance adjustments of the kill fluid in the reservoir to ensure that the density and other properties of the kill fluid are appropriate for current downhole conditions. In some embodiments, the kill fluid may include one or more of a water-based kill fluid, an oil-based kill fluid, a synthetic-based kill fluid, a foam or gas-based kill fluid, a high-density kill fluid, a calcium-based kill fluid, and a brine kill fluid, or the like.

The mud mixing pit 3 refers to a facility for mixing and preparing the drilling fluid or the kill fluid. The drilling fluid or kill fluid treated in the mud mixing pit 3 ensures that the drilling fluid or kill fluid have the proper physical and chemical properties to meet specific drilling conditions and requirements. The design and use of the mud mixing pit 3 maintain the stability of the drilling fluid performance as well as improve drilling efficiency.

In some embodiments, to facilitate on-site preparation of the kill fluid and drilling fluid, the mud mixing pit 3 is provided with a density adjustment pit and a viscosity adjustment pit.

The density adjustment pit refers to a facility that regulates the density of the fluid in a mud mixing pit. In some embodiments, the density adjustment pit may be configured to increase or decrease the density of the drilling fluid by adding a weighting agent (e.g., barite and hematite, etc.) or diluent to equalize downhole pressure. In some embodiments, the density adjustment pit may be configured to quickly adjust the density of the drilling fluid when different pressure gradients are encountered, ensuring that the drilling fluid has sufficient well control capability.

The viscosity adjustment pit is a facility that regulates the viscosity of the fluid in the mud mixing pit. In some embodiments, the viscosity adjustment pit may be configured to alter the rheological properties of the drilling fluid by adding a tackifier (e.g., bentonite and polymers, etc.) or diluent to improve the ability to carry rock cuttings. In some embodiments, the viscosity adjustment pit may also be configured to adjust the viscosity based on borehole cleanliness and drill cuttings transportation requirements, preventing borehole problems such as well plugging or collapse.

In embodiments of the present disclosure, the density adjustment pit and the viscosity adjustment pit are provided on the mud mixing pit, allowing for more precise and efficient adjustment of key performance parameters of the drilling fluid to adapt to different downhole conditions and drilling requirements.

The drilling tool lifting device may be configured to quickly and efficiently control the up and down of the drilling tool for replacement or maintenance, or adjust the pressure applied by the drilling string. In some embodiments, the drilling tool lifting device primarily includes a derrick, a drawwork, a traveling block, a clamp, a large hook, etc.

In some embodiments, as shown in FIG. 1, the drilling tool lifting device may include a first pulley set 15, a second pulley set 30, a third pulley set 32, and an electric winch 9. A wire rope 28 of the electric winch 9 is connected to the top end of the drilling string 13 after passing through the third pulley set 32, the second pulley set 30, and the first pulley set 15 in sequence, and the electric winch 9 drives the drilling string 13 to be lifted.

The electric winch refers to a device that utilizes electric power for lifting and towing loads. The third pulley set 32 is located near the electric winch 9 and is configured to convert the vertical power provided by the electric winch 9 into horizontal power. The second pulley set 30 is located between the first pulley set 15 and the third pulley set 32 and is configured to convert the horizontal power that has been converted by the third pulley set 32 into vertical power that drives the drilling string 13. The first pulley set 15 is directly connected to the drilling string 13 to drive the drilling string 13.

The power provided by the electric winch 9 sequentially passes through the third pulley set 32, the second pulley set 30, and the first pulley set 15 through the wire rope to change the power direction and reach the drilling string 13, to drive the drilling string 13 to be lifted.

In the embodiment of the present disclosure, the electric winch 9 and the plurality of pulley sets may be set to efficiently and stably raise or lower the drilling string by electric power, so as to control the pressure applied by the drilling string and ensure that the drilling work proceeds smoothly.

In some embodiments, as shown in FIG. 1, a high-pressure gas storage tank 7 is connected to the target high-pressure formation simulation device 8 through a pipe, and a pressure reducing valve 23, a gas flow meter 20, a first one-way valve 26, and a first pressure sensor 21 are provided between the target high-pressure formation simulation device 8 and the high-pressure gas storage tank 7.

The high-pressure gas storage tank 7 may provide high-pressure gas to meet a variety of operational needs. For example, the high-pressure gas storage tank 7 may provide an adequate supply of gas or gas power to the target high-pressure formation simulation device 8. In some embodiments, the high-pressure gas storage tank 8 may be configured to store the compressed oxygen, nitrogen, air, etc.

The pressure reducing valve 23 refers to a device for reducing and stabilizing the fluid pressure. The pressure reducing valve 23 may reduce the pressure of the gas output from the high-pressure gas storage tank 7 to a desired level (e.g., a low-pressure level) to ensure stability of the gas flow and to ensure that the pipe and the target high-pressure formation simulation device 8 to which the gas reaches are not damaged by the high pressure.

In some embodiments, the gas flow meter 20 may include one or more of a mass flow meter, a volumetric flow meter, a mechanical flow meter, an ultrasonic flow meter, an acoustic flow meter, or the like. The gas flow meter 20 in embodiments of the disclosure may measure the flow velocity, flow rate, total amount, etc. of gas that is delivered from the high-pressure gas storage tank 7 to the target high-pressure formation simulation device 8 through the pressure reducing valve 23.

The first one-way valve 26 may control the gas output from the high-pressure gas storage tank 7 to be delivered to the target high-pressure formation simulation device 8, preventing the gas in the pipe flowing back into the high-pressure gas storage tank 7.

In some embodiments, the pressure sensor may include a strain gauge pressure sensor, a capacitive pressure sensor, a piezoelectric pressure sensor, a fiber optic pressure sensor, or the like.

The first pressure sensor 21 may be configured to measure the gas pressure output from the high-pressure gas storage tank 7.

In some embodiments, as shown in FIG. 1, the wellbore 11 is provided with a second pressure sensor 33, a third pressure sensor 34, and a fourth pressure sensor 35 in sequence from bottom to top, and the first pressure sensor 21, the second pressure sensor 33, the third pressure sensor 34, the fourth pressure sensor 35, and the liquid flow meter 18 are electrically connected to the data receiving terminal 29.

The second pressure sensor 33 is arranged on a side of the wellbore 11 close to the target high-pressure formation simulation device 8, the fourth pressure sensor 35 is arranged on a side of the wellbore 11 close to the blowout preventer 10, and the third pressure sensor 34 is arranged between the second pressure sensor 33 and the fourth pressure sensor 35. In some embodiments, the second pressure sensor 33, the third pressure sensor 34, and the fourth pressure sensor 35 may be disposed on the wellbore at a specific spacing, e.g., equidistant. The second pressure sensor 33, the third pressure sensor 34, and the fourth pressure sensor 35 may measure pressure within the wellbore at their corresponding positions, respectively.

The data receiving terminal 29 refers to a device or system that receives, processes, and stores information transmitted from various data sources. The data receiving terminal may include a processor and a storage device.

In some embodiments, the data receiving terminal 29 may receive data obtained from measurements of the first pressure sensor 21, the second pressure sensor 33, the third pressure sensor 34, the fourth pressure sensor 35, and the liquid flow meter 18. In some embodiments, the data receiving terminal 29 may also be connected to a display device to display the received measurement data.

In some embodiments, the experimental testing system 100 may further include a waste liquid treatment pit 16. The waste liquid treatment pit 16 is connected to the mud mixing pit 3 and the second electric valve 24 by pipes, respectively, and a waste liquid flow meter 27 is provided between the second electric valve 24 and the waste liquid treatment pit 16, and the waste liquid flow meter 27 is electrically connected to a data receiving terminal 29.

The waste liquid treatment pit 16 refers to a facility that collects, stores, and treats various waste fluids. The waste fluids may contain chemical additives, drill cuttings, and other contaminants, which must be properly treated to minimize environmental impact. The waste fluids may include the drilling fluid, and the waste fluid treatment pit may purify and treat the recovered drilling fluids for reuse.

The waste liquid flow meter 27 refers to a liquid flow meter for measuring waste liquid. The waste liquid flow meter 27 measures the flow rate of liquid output from the second electric valve 24 to the waste liquid treatment pit. The data receiving terminal 29 may receive and display the measured waste liquid flow.

In some embodiments, the first pressure sensor 21, the second pressure sensor 33, the third pressure sensor 34, and the fourth pressure sensor 35 may be deployed at a plurality of predetermined positions, respectively. The first pressure sensor 21, the second pressure sensor 33, the third pressure sensor 34, and the fourth pressure sensor 35 are only different in the set positions.

A predetermined position refers to a predetermined position for mounting the pressure sensor. In some embodiments, the predetermined position may be preset by a skilled person based on experience.

In some embodiments, the processor may preset a plurality of candidate sensor distributions, determine a target sensor distribution based on the plurality of candidate sensor distributions, and determine a plurality of predetermined positions based on the target sensor distribution.

A candidate sensor distribution refers to a sensor distribution used as a candidate. The sensor distribution includes a distribution of positions of multiple sensors. In some embodiments, the processor may randomly select positions of a plurality of sensors and generate the candidate sensor distribution.

The target sensor distribution refers to a sensor distribution selected from the candidate sensor distributions. In some embodiments, the processor may determine the target sensor distribution based on the candidate sensor distributions and experimental data. The experimental data refers to the data obtained by executing process 200 on the positions of the various sensors. For example, the experimental data includes at least cyclic pressures measured by the first, second, third, and fourth pressure sensors at operation 212 and a data sequence measured by the first, second, third, and fourth pressure sensors during the experiment.

In some embodiments, for each candidate sensor distribution, under the same experimental conditions, a plurality of sensors may be tested at positions corresponding to the candidate sensor distribution. The processor may eliminate outlier data of the cyclic pressure in the experimental data compared to cyclic pressures in other experimental data; calculate, in the experimental data after eliminating the outlier data, a reading fluctuation of the pressure sensor corresponding to the candidate sensor distribution during an experiment; eliminate the data with large fluctuation from the calculated reading fluctuation; randomly select a candidate sensor distribution in the eliminated data, and determine the randomly selected candidate sensor distribution as the target sensor distribution. The same experimental conditions mean that the eccentricity of the drilling string, the drilling fluid and other conditions are the same. The reading fluctuation of the candidate sensor distribution may be measured by the variance mean of the readings sequence of the four pressure sensors.

In some embodiments, the processor may eliminate outlier data in a plurality of ways. For example, the outlier data may be eliminated using the 30 rule.

In some embodiments, the processor may determine a plurality of sensor positions in the target sensor distribution as predetermined positions. The target sensor distribution includes a plurality of sensor positions.

In the embodiments of the present disclosure, an optimal sensor position is obtained by experimenting on the plurality of sensor positions, which is conducive to obtaining a more accurate experimental result.

In some embodiments, for each candidate sensor distribution, the processor may determine, based on the candidate sensor distributions and experimental parameters, a pressure reading accuracy corresponding to the candidate sensor distribution by an estimation model, and determine the target sensor distribution based on the pressure reading accuracies corresponding to the plurality of candidate sensor distributions.

In some embodiments, the experimental parameters may include the eccentricity of the drilling string and a drilling fluid ratio.

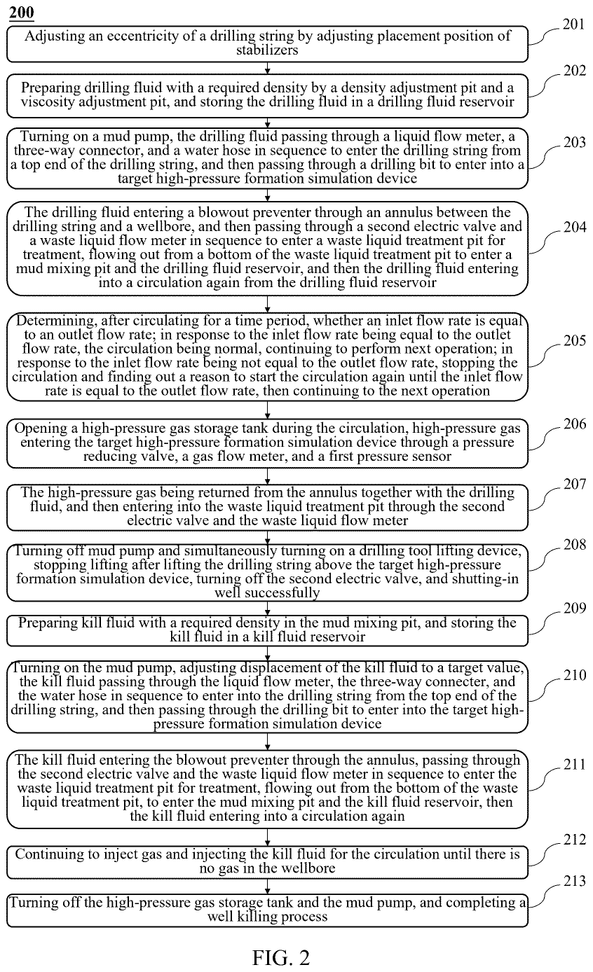

More descriptions regarding the eccentricity of the drilling string may be found in FIG. 2 and its related descriptions.

The drilling fluid ratio refers to the proportion of the constituent components in the drilling fluid and the preparation manner. In some embodiments, the drilling fluid ratio primarily refers to the density of the drilling fluid. More detailed descriptions regarding the density of the drilling fluid may be found in FIG. 2 and its related descriptions.

The pressure reading accuracy refers to the degree of agreement between the actual reading of the pressure sensor and the actual pressure value, which may also be understood as the precision of the sensor reading. In some embodiments, the pressure reading accuracy may include four accuracy values corresponding to the pressure reading accuracy of the first pressure sensor, the pressure reading accuracy of the second pressure sensor, the pressure reading accuracy of the third pressure sensor, and the pressure reading accuracy of the fourth pressure sensor, respectively.

The estimation model refers to a model that determines the pressure reading accuracy corresponding to the candidate sensor distribution. In some embodiments, the estimation model is a machine learning model. In some embodiments, the estimation model may be a convolutional neural network (CNN) model, a deep neural network (DNN) model, etc. The estimation model may also be a machine learning model with another structure such as a neural network model, a recurrent neural network model, or the like.

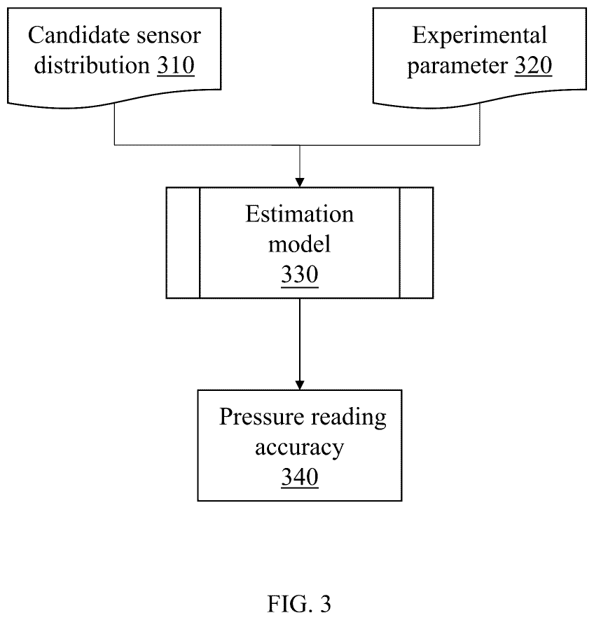

In some embodiments, as shown in FIG. 3, inputs of the estimation model 330 may include a candidate sensor distribution 310 and an experimental parameter 320, and an output of the estimation model 330 is a pressure reading accuracy 340 corresponding to the candidate sensor distribution.

In some embodiments, the processor may obtain a plurality of first training samples with first labels to constitute a first training sample set and obtain the estimation model by training the first training sample set.

In some embodiments, the first training samples of the estimation model may include sample sensor distributions and sample experimental parameters. The first labels may be pressure reading accuracies corresponding to the first training samples. The first training samples may be obtained from historical data, e.g., generating the first training samples based on the sensor distributions and corresponding experimental parameters in the historical data. The first labels may be subsequent actual pressure reading accuracies in the historical data corresponding to the first training samples. For each pressure sensor, the pressure reading accuracy may be obtained by calculating a difference between the actual reading of the pressure sensor and a fitted reading, dividing the difference by the actual reading, and obtaining an absolute value. The fitted reading is data obtained by fitting the pressure at the corresponding position of the pressure sensor using the equation (2) in operation 205.

In some embodiments, the processor may input the first training sample set into an initial estimation model to perform a plurality of rounds of iterations. Each round of iteration includes selecting one or more first training samples from the first training sample set, inputting the one or more first training samples into the initial estimation model, obtaining one or more model estimation output corresponding to the one or more first training samples; substituting one or more model estimation output and the first labels of the one or more first training samples into a formula of a predefined loss function to calculate a value of the loss function; inversely updating model parameters of the initial estimation model (e.g., based on the gradient descent algorithm) based on the value of the loss function. When an iteration end condition is satisfied, the iteration is ended to obtain the trained estimation model. The iteration end condition may be that the loss function converges, the number of iterations reaches a threshold, etc.

In some embodiment of the present disclosure, determining the pressure reading accuracy by the estimation model may utilize the self-learning capability of the machine learning model to find a rule from a large amount of historical data. Thus, a relationship between the candidate sensor distributions, the experimental parameters, and the pressure reading accuracy, etc., is obtained, thereby improving the accuracy and efficiency of determining the pressure reading accuracy.

In some embodiments, the processor may select, from a plurality of sets of pressure reading accuracies corresponding to the plurality of candidate sensor distributions (each set of pressure reading accuracies includes pressure reading accuracies corresponding to four pressure sensors), the candidate sensor distribution corresponding to the four accuracies in the set of pressure reading accuracies with the largest mean and/or the smallest variance as the target sensor distribution.

In some embodiments of the present disclosure, determining the pressure reading accuracy through the estimation model can reduce the cost of time and the consumption of equipment for the actual experiments, which improves efficiency and reduces the waste of resources.

In some embodiments, the processor may divide the plurality of first training samples into different sets when training the estimation model. The sets may include a plurality of training sets and a plurality of testing sets. The processor may input different sets into the initial estimation model in batches for training.

In some embodiments, the processor may determine training sets and testing sets for different sets based on different sample experimental parameters in the first training samples. The learning rate for each set is related to the accuracies of subsequent pressure readings of the first training samples.

In some embodiments, the processor may divide the first training samples based on sample experimental parameters. The processor may divide the eccentricity of the drilling string and drilling fluid ratios into multiple grades separately and then combine different grades of the eccentricity of the drilling string and the drilling fluid ratios in pairs to form a plurality of grade combinations. The processor may divide the samples into different training sets according to the grade combinations. For example, the eccentricity of the drilling string has two grades and the drilling fluid ratios have two grades, then four grade combinations may be formed by combining the two grades of the eccentricity of the drilling string and the two grades of drilling fluid ratios in pairs, and the samples are divided into four training sets based on the four grade combinations.

In some embodiments, the processor may randomly extract a predetermined percentage of training samples from each database among a plurality of databases to the testing set or training set. The database may include first training samples and corresponding first labels. The predetermined percentage is related to the objects formed by the extraction. For example, when the testing set and the training set are formed according to the predetermined percentage of 3:7, then the training samples used to form the training set have an extraction ratio of 0.7 in the database, and the training samples used to form the testing set have an extraction ratio of 0.3 in the database.

When updating model parameters based on the first training samples in the kth round of iteration, the used learning rate factor is related to the current iteration round k as well as the first training samples. The smaller the current iteration round k, the higher the pressure reading accuracy corresponding to the first training samples, and the larger the learning rate factor.

In some embodiments, the experimental testing system 100 may further include a fifth pressure sensor and a remote processor. The fifth pressure sensor may be arranged at the waste liquid treatment pit and configured to obtain a pressure of the waste liquid treatment pit. The remote processor is configured to predict, in response to an inlet flow rate not being equal to an outlet flow rate, pipe anomaly data based on pressure data of the waste liquid treatment pit and the outlet flow rate by an anomaly prediction model.

The remote processor refers to a processor located at a position away from the wellbore, which is also referred to as the processor. In some embodiments, the remote processor may be connected to a data receiving terminal to receive and process data.

The pressure data of the waste liquid treatment pit refers to pressure data obtained from measurement of the sensor during the operation of the waste liquid treatment pit. The pressure data of the waste liquid treatment pit may be obtained by measuring with the fifth pressure sensor.

The outlet flow rate of the waste liquid treatment pit refers to the amount of waste liquid discharged from the waste liquid treatment pit per unit time. The outlet flow rate of the waste liquid treatment pit may be obtained by measuring with the waste liquid flow meter.

The inlet flow rate refers to the flow rate of liquid entering the target high-pressure formation simulation device per unit time. The inlet flow rate may be obtained by measuring with a liquid flow meter. Further descriptions regarding the inlet flow rate may be found in FIG. 2 and its related descriptions.

The pipe anomaly data refers to data characterizing the cause of pipe anomaly. In some embodiments, the pipe anomaly data may include pipe blockage, pipe leakage, or the like.

The anomaly prediction model refers to a model that predicts the pipe anomaly data. In some embodiments, the anomaly prediction model is a machine learning model. In some embodiments, the anomaly prediction model may be a convolutional neural network (CNN) model and a deep neural network (DNN) model, etc. The anomaly prediction model may also be a machine learning model with another structure such as a neural network model, a recurrent neural network model, or the like.

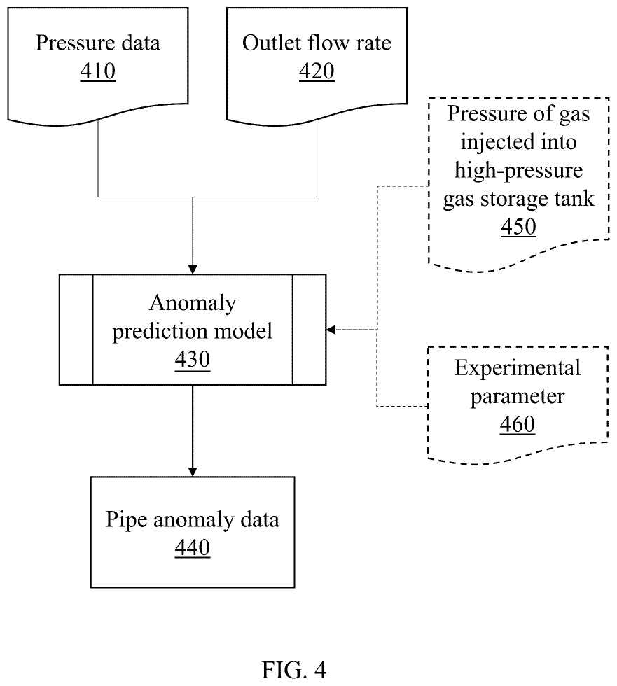

In some embodiments, as shown in FIG. 4, inputs to the anomaly prediction model 430 may include pressure data 410 and outlet flow rate 420 of the waste liquid treatment pit, and an output of the anomaly prediction model 430 may include pipe anomaly data 440.

In some embodiments, the processor may obtain a plurality of second training samples with second labels to form a second training sample set and obtain the anomaly prediction model by training using the second training sample set.

In some embodiments, the second training samples of the anomaly prediction model may include sample pressure data and sample outlet flow rate of the waste liquid treatment pit. The second labels may be actual anomaly causes corresponding to the second training samples. The second training samples may be obtained from the historical data, for example, the second training samples are generated based on the pressure data and outlet flow rate of the waste liquid treatment pit in which the cycling anomaly occurred in the historical data. The second labels may be anomaly causes found in the historical data corresponding to the second training samples during the cycling anomaly, e.g., an anomaly found by manual troubleshooting. More descriptions regarding the cyclic anomaly may be found in FIG. 2 and its related descriptions.

The training process of the anomaly prediction model is similar to that of the estimation model and is not repeated herein.

In the embodiment of the present disclosure, determining pipe anomaly data by the anomaly prediction model may utilize the self-learning ability of the machine learning model to find a rule from a large amount of historical data. Thus, a relationship between the pressure data, the outlet flow rate, and the pipe anomaly data, etc., of the waste liquid treatment pit is obtained, thereby improving the accuracy and efficiency of determining the pipe anomaly data. At the same time, determining the pipe anomaly data through the anomaly prediction model may reduce the time and cost consumption of troubleshooting and quick and accurate position, thereby solving the problem efficiently and improving the efficiency of the experiment. In some embodiments, the second labels may also be determined based on the change in data by injecting gases of different pressures into a gas storage cylinder. Exemplarily, when the gas is injected into the gas storage cylinder, if only the data of the second pressure sensor does not change, it may be determined that there is a problem at the second pressure sensor.

In some embodiments, the pipe anomaly data includes a predicted pipe region in which the anomaly occurs. The inputs of the anomaly prediction model may also include the pressure of the gas injected into the high-pressure gas storage tank 450 and the experimental parameters 460.

The predicted pipe region refers to a region where the anomaly occurs as predicted by the anomaly prediction model. The pressure of the gas injected into the high-pressure gas storage tank may be obtained by measuring with the gas flow meter.

In some embodiments, the second training samples of the anomaly prediction model may also include a sample pressure of the gas injected into a high-pressure gas storage tank and sample experimental parameters.

In the embodiment of the present disclosure, inputting other experimental parameters into the anomaly prediction model may well simulate the actual experimental scenarios to locate the fault in a certain region, which is conducive to subsequent rapid overhaul and adjustment of the anomaly.

FIG. 2 is a flowchart illustrating an exemplary experimental testing method for a wellbore pressure during a well killing process under a complex working condition according to some embodiments of the present disclosure. In some embodiments, the process 200 may be performed by an experimental testing system for a wellbore pressure during a well killing process under a complex working condition.

As shown in FIG. 2, the process 200 includes the following operations.

In some embodiments, the processor may adjust the eccentricity of the drilling string by adjusting the placement position of the stabilizers; prepare the drilling fluid with a required density by the density adjustment pit and the viscosity adjustment pit, and store the drilling fluid in the drilling fluid reservoir; and turn on the mud pump to cause that the drilling fluid passes through the liquid flow meter, the three-way connector, and the water hose in sequence, to enter the drilling string from the top end of the drilling string, and then passes through the drilling bit into the target high-pressure formation simulation device, at this time, the inlet flow rate being the reading Q₁ of the liquid flow meter. The drilling fluid that enters the target high-pressure formation simulation device enters the blowout preventer through the annulus between the drilling string and the wellbore, and then passes through the second electric valve and the waste liquid flow meter in sequence to enter the waste liquid treatment pit, flows out from the bottom of the waste liquid treatment pit after treatment in the waste liquid treatment pit to enter the mud mixing pit and the drilling fluid reservoir, and then the drilling fluid enters into a circulation again from the drilling fluid reservoir, wherein an outlet flow rate is a reading Q₂ of the waste liquid flow meter. The processor may determine, after circulating for a time period, whether the inlet flow rate is equal to the outlet flow rate; in response to determining that the inlet flow rate is equal to the outlet flow rate, indicating that the circulation is normal, continue to a next operation; in response to determining that the inlet flow rate is not equal to the outlet flow rate, stop the circulation and find out a reason to start the circulation again until the inlet flow rate is equal to the outlet flow rate, then continue to next operation. At this time, readings of the first pressure sensor, the second pressure sensor, the third pressure sensor, and the fourth pressure sensor are P₁, P₂, P₃, and P₄, respectively. The processor may open the high-pressure gas storage tank during the circulation, and high-pressure gas enters the target high-pressure formation simulation device through the pressure reducing valve, the gas flow meter, and the first pressure sensor. At this time, a pressure of the pressure reducing valve is P_{g}, a reading of the gas flow meter is Q_{g1}, and a reading of the first pressure sensor is P′₁. The high-pressure gas that enters the target high-pressure formation simulation device is returned from the annulus together with the drilling fluid, and then enters into the waste liquid treatment pit through the second electric valve and the waste liquid flow meter. At this time, readings of the second pressure sensor, the third pressure sensor, the fourth pressure sensor, and the waste liquid flow meter are P′₂, P′₃, P′₄, and Q₃, respectively. The processor may turn off the mud pump and simultaneously turn on the drilling tool lifting device, stop lifting after lifting the drilling string above the target high-pressure formation simulation device, turn off the second electric valve, and shut-in well successfully; prepare a kill fluid with a required density in the mud mixing pit, and store the kill fluid in the kill fluid reservoir; turn on the mud pump, and adjust a displacement of the kill fluid to a target value, wherein the kill fluid passes through the liquid flow meter, the three-way connecter, and the water hose in sequence to enter into the drilling string from the top end of the drilling string, and then passes through the drilling bit to enter into the target high-pressure formation simulation device, at this time, the reading of the liquid flow meter is Qₘ₁. The kill fluid that enters the target high-pressure formation simulation device enters the blowout preventer through the annulus between the drilling string and the wellbore, passes through the second electric valve and the waste liquid flow meter in sequence to enter the waste liquid treatment pit, flows out from the bottom of the waste liquid treatment pit after treatment in the waste liquid treatment pit, to enter the mud mixing pit and the kill fluid reservoir, then the kill fluid enters into a circulation again. At this time, the reading of the waste liquid flow meter is Qₘ₂, and the readings of the first pressure sensor, the second pressure sensor, the third pressure sensor, and the fourth pressure sensor are P″₁, P″₂, P″₃, and P″₄, respectively. The processor may then continue to inject gas and inject the kill fluid for the circulation until there is no gas in the wellbore, wherein final circulation pressures measured by the first pressure sensor, the second pressure sensor, the third pressure sensor, and the fourth pressure sensor are P^{e}₁, P^{e}₂, P^{e}₃, and P^{e}₄, respectively. The processor may turn off the high-pressure gas storage tank and the mud pump and complete the well killing process.

In operation 201, the eccentricity of the drilling string is adjusted by adjusting the placement position of the stabilizers.

The eccentricity of the drilling string refers to the degree to which the drilling string deviates from the ideal center position in the borehole. The eccentricity of the drilling string may be expressed as a ratio of a distance between the center of the drilling string and the center of the borehole to a difference between the diameter of the borehole and the diameter of the drilling string. The bending degree and stability of the drilling string in the borehole may be effectively controlled by adjusting the placement position of the stabilizers, thereby adjusting the eccentricity of the drilling string.

In some embodiments, the processor may determine the eccentricity of the drilling string based on a distance between two centers of the wellbore and the drilling pipe on an axial section of the wellbore, an inner diameter of the wellbore, and an outer diameter of the drilling string.

The distance between the two centers of the wellbore and the drilling pipe on the axial section of the wellbore may be understood to be the distance between a projection of the circle center of the wellbore and a projection of the circle center of the drilling pipe on the axial section of the wellbore, which may be obtained by measurement.

In some embodiments, the processor may determine the eccentricity of the drilling string by the following equation (1):

$$ε = \frac{Δ x}{{d}_{i n 1} - {d}_{out 2}} \qquad ( 1 )$$

where ε denotes the eccentricity of the drilling string; Δx denotes the distance between two centers of the wellbore and the drilling pipe on an axial section of the wellbore, dᵢₙ₁ denotes an inner diameter of the wellbore, dₒᵤₜ₂ denotes an outer diameter of the drilling string, and Δx, dᵢₙ₁ and dₒᵤₜ₂ have a unit of m.

In operation 202, the drilling fluid with the required density is prepared by the density adjustment pit and the viscosity adjustment pit, and the drilling fluid is stored in the drilling fluid reservoir.

The density of the drilling fluid affects the pressure control in the borehole, the stability of the well wall, and the safety and efficiency of drilling. The required density of the drilling fluid may be set empirically. In some embodiments, the density of the drilling fluid may be increased or decreased in the density adjustment pit by adding weighting agents or diluents.

In operation 203, the mud pump is turned on, the drilling fluid passes through the liquid flow meter, the three-way connector, and the water hose in sequence to enter the drilling string from the top end of the drilling string, and then pass through the drilling bit to enter into the target high-pressure formation simulation device. At this time, the inlet flow rate is a reading Q₁ of the liquid flow meter.

The inlet flow rate Q₁ is the volume of liquid entering the target high-pressure formation simulation device per unit time, with a unit of L/h.

In operation 204, the drilling fluid that enters the target high-pressure formation simulation device enters the blowout preventer through an annulus between the drilling string and the wellbore, and then passes through the second electric valve and the waste liquid flow meter in sequence to enter the waste liquid treatment pit, flows out from a bottom of the waste liquid treatment pit after treatment in the waste liquid treatment pit to enter the mud mixing pit and the drilling fluid reservoir, and then the drilling fluid enters into a circulation again from the drilling fluid reservoir, i.e., a drilling fluid circulation. At this time, the outlet flow rate is a reading Q₂ of the waste liquid flow meter.

The outlet flow rate Q₂ is the volume of waste liquid discharged from the waste liquid treatment pit per unit time, with a unit of L/h.

The drilling fluid circulation refers to a cycling process of the drilling fluid output from the drilling fluid reservoir undergoing operations 203 and 204.

In operation 205, after circulating for a time period, it is determined whether the inlet flow rate is equal to the outlet flow rate; in response to determining that the inlet flow rate is equal to the outlet flow rate, indicating that the circulation is normal, a next operation is continued to perform; in response to determining that the inlet flow rate is not equal to the outlet flow rate, the circulation is stopped and a reason is found out to start the circulation again until the inlet flow rate is equal to the outlet flow rate, then the next operation is continued to perform. At this time, readings of the first pressure sensor, the second pressure sensor, the third pressure sensor, and the fourth pressure sensor are P₁, P₂, P₃, and P₄, respectively.

The circulation in operation 205 refers to drilling fluid circulation. In some embodiments, the inlet flow rate Q₁ and an outlet flow rate Q₂ may be compared, in response to the inlet flow rate being equal to the outlet flow rate, the circulation is determined to be normal; and in response to the inlet flow rate not being equal to the outlet flow rate, the circulation is determined to be abnormal.

In response to the circulation being normal, operation 206 may continue to be executed. In response to the circulation being abnormal, the circulation is stopped and a reason is found out to start the circulation again until the inlet flow rate is equal to the outlet flow rate, at this time, the circulation is determined to be normal, and operation 206 may be continued to be executed.

In some embodiments, the pressure at a particular position of the wellbore may be determined based on the density of the drilling fluid, the depth of the wellbore at the position, the displacement of the drilling fluid, and the friction factor. The density of the drilling fluid may be determined in operation 202. The depth of the wellbore at the position may be obtained by measurement. The displacement of the drilling fluid may be obtained by measurement with the fluid flow meter. The friction factor may be obtained by querying.

In some embodiments, the processor may determine the pressure at a particular position of the wellbore according to the following equation (2):

$${P}_{x} = 9.81 {ρ}_{0} {H}_{x} + \frac{2 {Q}_{1} {ρ}_{0} {f}_{1} {H}_{x}}{{( {d}_{i n 1} - {d}_{out 2} )}^{3}} , ( x = 1 , 2 , 3 , 4 ) , \qquad ( 2 )$$

where Pₓ denotes the pressure at a particular position of the wellbore with a unit of MPa; ρ₀ denotes the density of the drilling fluid with a unit of kg/m³; Hₓ denotes the depth of the wellbore at that position with a unit of m; Q₁ denotes the displacement of the drilling fluid with a unit of L/s; and f₁ denotes the friction factor, which is dimensionless.

In operation 206, the high-pressure gas storage tank is opened during the circulation, the high-pressure gas enters the target high-pressure formation simulation device through the pressure reducing valve, the gas flow meter, and the first pressure sensor. At this time, the pressure of the pressure reducing valve is P_{g}, the reading of the gas flow meter is Q_{g1}, and the reading of the first pressure sensor is P′₁.

The circulation in operation 206 refers to the drilling fluid circulation. In some embodiments, the processor may determine the flow rate of the injected gas based on an adiabatic index, a pressure of the injected gas, and a velocity of the injected gas. The adiabatic index refers to a value that characterizes the expansion or compression behavior of the gas without heat exchange with the outside world (i.e., during adiabatic processes). The adiabatic index may be obtained by querying. The pressure of the injected gas may be obtained by the measurement with the first pressure sensor. The velocity of the injected gas may be obtained by the measurement with the gas flow meter.

In some embodiments, the processor may determine the flow rate of the injected gas according to the following equation (3):

$${Q}_{g 1} = 36 \sqrt{9.81 \times k \times {( \frac{2}{1 + k} )}^{\frac{k + 1}{k - 1}}} \times \frac{{P}_{g}}{v} , \qquad ( 3 )$$

where Q_{g1} denotes the flow rate of the injected gas with a unit of L/h; k denotes the adiabatic index, P_{g} denotes the pressure of the injected gas with a unit of MPa; v denotes the velocity of the injected gas with a unit of m/s. The adiabatic index may be determined based on the type of gas used in the high-pressure gas storage tank. For example, if the gas employed in the high-pressure gas storage tank is nitrogen, the adiabatic index k may be selected as 1.4.

In operation 207, the high-pressure gas that enters the target high-pressure formation simulation device is returned from the annulus together with the drilling fluid, and then enters into the waste liquid treatment pit through the second electric valve and the waste liquid flow meter. At this time, readings of the second pressure sensor, the third pressure sensor, the fourth pressure sensor, and the waste liquid flow meter are P′₂, P′₃, P′₄, and Q₃, respectively.

P′1 is less than P1, P′2 is less than P2, P′3 is less than P3, and P′4 is less than P4.

In some embodiments, the pressure at a particular position of the wellbore after outputting gas from the high-pressure gas storage tank may be determined based on the density of the drilling fluid in each section of the annulus, the depth of the drilling fluid in each section of the wellbore, the flow rate of the drilling fluid in each section of the wellbore, and the friction factor.

In some embodiments, the processor may determine the pressure

$${P}_{x}^{′}$$

at a particular position of the wellbore after the gas is output from the high-pressure gas storage tank according to the following equations (4) and (5):

$${P}_{x}^{′} = 0.009 \; 81 {\sum }_{i = 1}^{Z} {ρ}_{i} {gH}_{i} + {\sum }_{i = 1}^{Z} \frac{8 {Q}_{i} ρ {f}_{i} {H}_{i}}{{( {d}_{i n 1} - {d}_{out 2} )}^{3}} , ( x = 1 , 2 , 3 , 4 ) ; \qquad ( 4 )$$

$${Q}_{i} = {Q}_{g i} + {Q}_{g l} . \qquad ( 5 )$$

Where

$${P}_{x}^{′}$$

denotes the pressure at a particular position of the wellbore after the gas is output from the high-pressure gas storage tank with a unit of MPa; ρᵢ denotes the density of the ith section of the annulus with a unit of kg/m³; Hᵢ denotes the depth of drilling fluid in the ith section of the wellbore with a unit of m; Qᵢ denotes the flow rate of the fluid column in the ith section of the wellbore with a unit of L/s; fᵢ denotes the friction factor, which is dimensionless.

In operation 208, the mud pump is turned off and the drilling tool lifting device is simultaneously turned on, lifting is stopped after lifting the drilling string above the target high-pressure formation simulation device, the second electric valve is turned off, and well is shut-in successfully.

There is no contact between the drilling string and the target high-pressure formation simulation device after the drilling string is lifted above the target high-pressure formation simulation device, and at this time, the drilling string does not apply pressure on the target high-pressure formation simulation device.

In operation 209, the kill fluid with a required density is prepared in the mud mixing pit, and the kill fluid is stored in the kill fluid reservoir.

The density of the kill fluid affects the pressure control in the borehole as well as the safety of drilling. The required density of the kill fluid may be set empirically. In some embodiments, the density of the kill fluid may be increased or decreased in the density adjustment pit by adding weighting agents or diluents.

In some embodiments, the density of the kill fluid is greater than the density of the drilling fluid. In some embodiments, the density of the kill fluid may be determined based on the density of the drilling fluid and a measured stable standpipe pressure. The stable standpipe pressure refers to the pressure exerted at the top by the fluid (e.g., the drilling fluid) in the standpipe (e.g., in the wellbore). The stable standpipe pressure may be obtained by measurement.

In some embodiments, the processor may determine the density of the kill fluid according to the following equation (6):

$${ρ}_{1} = \frac{{p}_{5 , w}}{9.81 {H}_{i}} + {ρ}_{0} , \qquad ( 6 )$$

where p_{5,w} denotes the measured stable standpipe pressure with a unit of MPa; ρ₁ denotes the density of the kill fluid with a unit of kg/m³; and ρ₀ denotes the density of the drilling fluid with a unit of kg/m³.

In operation 210, the mud pump is turned on, a displacement of the kill fluid is adjusted to a target value, and the kill fluid passes through the liquid flow meter, the three-way connecter, and the water hose in sequence to enter into the drilling string from the top end of the drilling string, and then passes through the drilling bit to enter into the target high-pressure formation simulation device. At this time, the reading of the liquid flow meter is Qₘ₁.

The target value is the displacement of the kill fluid required to balance the downhole pressure. The target value may be obtained based on downhole pressure calculations.

In operation 211, the kill fluid that enters the target high-pressure formation simulation device enters the blowout preventer through the annulus, passes through the second electric valve and the waste liquid flow meter in sequence to enter the waste liquid treatment pit, flows out from the bottom of the waste liquid treatment pit after treatment in the waste liquid treatment pit, to enter the mud mixing pit and the kill fluid reservoir, then the kill fluid enters into a circulation again, i.e. a kill fluid circulation. At this time, the reading of the waste liquid flow meter is Qₘ₂, and the readings of the first pressure sensor, the second pressure sensor, the third pressure sensor, and the fourth pressure sensor are P″₁, P″₂, P″₃, and P″₄, respectively.

The kill fluid circulation refers to the circulating process of the kill fluid undergoing operations 210 and 211 after the kill fluid is output from the kill fluid reservoir.

In some embodiments, the processor may further determine a pressure

$${P}_{x}^{″}$$

at a particular position of the wellbore after the kill fluid is inputted based on the wellhead back pressure.

In some embodiments, the processor may determine the pressure

$${P}_{x}^{″}$$

at a particular position of the wellbore after the kill fluid is inputted according to the following equation (7):

$${P}_{x}^{″} = 0.009 \; 81 {\sum }_{i = 1}^{Z} {ρ}_{i} {gH}_{i} + {\sum }_{i = 1}^{Z} \frac{8 {Q}_{i} {ρ}_{i} {f}_{i} {H}_{i}}{{( {d}_{i n 1} - {d}_{out 2} )}^{3}} + {P}_{bp} , ( x = 1 , 2 , 3 , 4 ) , \qquad ( 7 )$$

where P_{bp} denotes the wellhead back pressure with a unit of MPa. The wellhead back pressure may be adjusted by adjusting the second electric valve.

In operation 212, gas is continued to be injected, and the kill fluid is injected for the circulation until there is no gas in the wellbore. At this time, the final circulation pressures measured by the first pressure sensor, the second pressure sensor, the third pressure sensor, and the fourth pressure sensor are Pₑ₁, Pₑ₂, Pₑ₃, and Pₑ₄, respectively.

The circulation in operation 212 refers to the kill fluid circulation.

In some embodiments, the processor may determine a pressure

$${P}_{x}^{″}$$

at a particular position of the wellbore after circulation of the kill fluid based on the density of the kill fluid, the displacement of the kill fluid, and the friction factor. The displacement of the kill fluid may be obtained by measurement with the fluid flow meter.

In some embodiments, the processor may determine the pressure

$${P}_{x}^{″}$$

at a particular position of the wellbore after circulation of the kill fluid according to the following equation (8):

$${P}_{x}^{e} = 0.00981 {ρ}_{1} {H}_{x} + \frac{2 {Q}_{4} {ρ}_{1} {f}_{1} {H}_{x}}{{( {d}_{i n 1} - {d}_{out 2} )}^{3}} , ( x = 1 , 2 , 3 , 4 ) . \qquad ( 8 )$$

Where ρ₁ denotes the density of the kill fluid with a unit of kg/m³; Q₄ denotes the displacement of the kill fluid with a unit of L/s; f₁ denotes the friction factor, which is dimensionless.

In operation 213, the high-pressure gas storage tank and the mud pump are turned off, and the well killing process is completed.

In embodiments of the present disclosure, the wellbore pressure is predicted during the well killing process by combining a variety of conditions to simulate the well killing manners under different complex conditions, thereby monitoring the safety risk at the wellhead.

It should be noted that the foregoing description of the process 200 is for the purpose of exemplification and illustration only and does not limit the scope of application of the present disclosure. For a person skilled in the art, various corrections and changes can be made to the process 200 under the guidance of the present disclosure. However, these corrections and changes remain within the scope of the present disclosure.

The foregoing is not a limitation of the present invention in any form, and although the present disclosure has been revealed by the above embodiments, it is not intended to qualify the present disclosure. Any person skilled in the art may, without departing from the scope of the technical scheme of the present disclosure, utilize the technical content of the above disclosure to make some changes or modifications to the equivalent embodiments of equivalent changes, but any simple modifications, equivalent changes and modifications made to the above embodiments based on the technical substance of the present disclosure without departing from the content of the technical scheme of the present invention fall within the scope of the technical scheme of the present disclosure.

One or more embodiments of the present disclosure provide an experimental testing device for a wellbore pressure during a well killing process under a complex working condition, including a processor. The processor is configured to perform the experimental testing method for the wellbore pressure during the well killing process under the complex working condition as described in any one embodiment of the present disclosure.

One or more embodiments of the present disclosure provide a non-transitory computer-readable storage medium storing computer instructions. When a computer reads the computer instructions in the storage medium, the computer performs the experimental testing method for the wellbore pressure during the well killing process under the complex working condition.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

What is claimed is:

1. An experimental testing system for a wellbore pressure during a well killing process under a complex working condition, comprising a target high-pressure formation simulation device, a wellbore, a drilling string, a blowout preventer, a drilling fluid reservoir, a kill fluid reservoir, a mud mixing pit, a mud pump, a high-pressure gas storage tank, a drilling tool lifting device, a three-way connector, a water hose, a data receiving terminal, and a drilling bit, wherein
an upper end and a lower end of the wellbore are connected to the blowout preventer and the target high-pressure formation simulation device by flanges, respectively; two sides of the blowout preventer are provided with a first electric valve and a second electric valve; the drilling string is vertically installed in the blowout preventer, and a bottom end of the drilling string is connected to the drilling bit and extends into the target high-pressure formation simulation device; and the drilling string is located on an outer wall inside the wellbore, and three stabilizers are provided on the outer wall;
a left end of the three-way connector is connected to the mud pump through a pipe, a right end of the three-way connector is connected to the first electric valve through a pipe, and an upper end of the three-way connector is connected to a top end of the drilling string through the water hose; and a liquid flow meter and a second one-way valve are provided between the mud pump and the three-way connector;
the mud pump is connected to the drilling fluid reservoir and the kill fluid reservoir through pipes, respectively, and the mud mixing pit is connected to the drilling fluid reservoir and the kill fluid reservoir through pipes, respectively;
the top end of the drilling string is connected to the drilling tool lifting device, which is configured to lift the drilling string;
the high-pressure gas storage tank is connected to the target high-pressure formation simulation device by a pipe, and a pressure reducing valve, a gas flow meter, a first one-way valve, and a first pressure sensor are provided between the target high-pressure formation simulation device and the high-pressure gas storage tank; and
the wellbore is provided with a second pressure sensor, a third pressure sensor, and a fourth pressure sensor in sequence from bottom to top, and the first pressure sensor, the second pressure sensor, the third pressure sensor, the fourth pressure sensor, and the liquid flow meter are all electrically connected to the data receiving terminal.

2. The experimental testing system of claim 1, further comprising a waste liquid treatment pit connected to the mud mixing pit and the second electric valve via pipes, respectively, and a waste liquid flow meter electrically connected to the data receiving terminal is provided between the second electric valve and the waste liquid treatment pit.

3. The experimental testing system of claim 2, wherein the mud mixing pit is provided with a density adjustment pit and a viscosity adjustment pit.

4. The experimental testing system of claim 1, wherein the drilling tool lifting device includes a first pulley set, a second pulley set, a third pulley set, and an electric winch; and a wire rope of the electric winch is connected to the top end of the drilling string after passing through the first pulley set, the second pulley set, the third pulley set in sequence, and the electric winch drives the drilling string to be lifted.

5. The experimental testing system of claim 1, wherein the target high-pressure formation simulation device is a cylinder.

6. An experimental testing method for a wellbore pressure during a well killing process under a complex working condition, wherein the method is tested using the experimental testing system for the wellbore pressure during the well killing process under the complex working condition of claim 3, and the method comprises:
adjusting an eccentricity of the drilling string by adjusting a placement position of the stabilizers;
preparing a drilling fluid with a required density by the density adjustment pit and the viscosity adjustment pit, and storing the drilling fluid in the drilling fluid reservoir;
turning on the mud pump, the drilling fluid passing through the liquid flow meter, the three-way connector, and the water hose in sequence to enter the drilling string from the top end of the drilling string, and then passing through the drilling bit to enter into the target high-pressure formation simulation device, wherein an inlet flow rate is a reading Q of the liquid flow meter;
the drilling fluid that enters the target high-pressure formation simulation device entering the blowout preventer through an annulus between the drilling string and the wellbore, and then passing through the second electric valve and the waste liquid flow meter in sequence to enter the waste liquid treatment pit, flowing out from a bottom of the waste liquid treatment pit after treatment in the waste liquid treatment pit to enter the mud mixing pit and the drilling fluid reservoir, and then the drilling fluid entering into a circulation again from the drilling fluid reservoir, wherein an outlet flow rate is a reading Q₂ of the waste liquid flow meter;
determining, after circulating for a time period, whether the inlet flow rate is equal to the outlet flow rate; in response to determining that the inlet flow rate is equal to the outlet flow rate, indicating that the circulation is normal, continuing to a next operation; in response to determining that the inlet flow rate is not equal to the outlet flow rate, stopping the circulation and find out a reason to start the circulation again until the inlet flow rate is equal to the outlet flow rate, then continuing to next operation, wherein readings of the first pressure sensor, the second pressure sensor, the third pressure sensor, and the fourth pressure sensor are P₁, P₂, P₃, and P₄, respectively;
opening a high-pressure gas storage tank during the circulation, high-pressure gas entering the target high-pressure formation simulation device through the pressure reducing valve, the gas flow meter, and the first pressure sensor; wherein a pressure of the pressure reducing valve is P_{g}, a reading of the gas flow meter is Q_{g1}, and a reading of the first pressure sensor is P′₁;
the high-pressure gas that enters the target high-pressure formation simulation device being returned from the annulus together with the drilling fluid, and then entering into the waste liquid treatment pit through the second electric valve and the waste liquid flow meter, wherein readings of the second pressure sensor, the third pressure sensor, the fourth pressure sensor, and the waste liquid flow meter are P′₂, P′₃, P′₄, and Q₃, respectively;
turning off the mud pump and simultaneously turning on the drilling tool lifting device, stopping lifting after lifting the drilling string above the target high-pressure formation simulation device, turning off the second electric valve, and shutting-in well successfully;
preparing a kill fluid with a required density in the mud mixing pit, and storing the kill fluid in the kill fluid reservoir;
turning on the mud pump, adjusting a displacement of the kill fluid to a target value, the kill fluid passing through the liquid flow meter, the three-way connecter, and the water hose in sequence to enter into the drilling string from the top end of the drilling string, and then passing through the drilling bit to enter into the target high-pressure formation simulation device, wherein the reading of the liquid flow meter is Qₘ₁;
the kill fluid that enters the target high-pressure formation simulation device entering the blowout preventer through the annulus between the drilling string and the wellbore, passing through the second electric valve and the waste liquid flow meter in sequence to enter the waste liquid treatment pit, flowing out from the bottom of the waste liquid treatment pit after treatment in the waste liquid treatment pit, to enter the mud mixing pit and the kill fluid reservoir, then the kill fluid entering into a circulation again, wherein the reading of the waste liquid flow meter is Qₘ₂; the readings of the first pressure sensor, the second pressure sensor, the third pressure sensor, and the fourth pressure sensor are P″₁, P″₂, P″₃, and P″₄, respectively;
continuing to inject gas and injecting the kill fluid for the circulation until there is no gas in the wellbore, wherein final circulation pressures measured by the first pressure sensor, the second pressure sensor, the third pressure sensor, and the fourth pressure sensor are P^{e}₁, P^{e}₂, P^{e}₃, and P^{e}₄, respectively; and
turning off the high-pressure gas storage tank and the mud pump, and completing the well killing process.

7. The experimental testing method of claim 6, wherein the eccentricity of the drilling string is determined by an equation:
$$ε = \frac{Δ x}{{d}_{i n 1} - {d}_{out 2}} ,$$
wherein ε denotes the eccentricity of the drilling string; Δx denotes a distance between two centers of the wellbore and a drilling pipe along an axial section of the wellbore, dᵢₙ₁ denotes an inner diameter of the wellbore, dₒᵤₜ₂ denotes an outer diameter of the drilling string, and Δx, dᵢₙ₁ and dₒᵤₜ₂ have a unit of m.

8. The experimental testing method of claim 6, wherein the density of the kill fluid is greater than the density of the drilling fluid, wherein a relationship between the density of the kill fluid and the density of the drilling fluid is represented as follows:
$${ρ}_{1} = \frac{{p}_{5 , w}}{9.81 {H}_{i}} + {ρ}_{0} ,$$
wherein p_{5,w} denotes a measured stable standpipe pressure with a unit of MPa; ρ₁ denotes the density of the kill fluid with a unit of kg/m³; and ρ₀ denotes the density of the drilling fluid with a unit of kg/m³.
